(19) United States
(12) Patent Application Publication
(10) Pub. No.: US 2006/0097434 A1
(43) Pub. Date: May 11, 2006

(54) Pneumatic spring

(75) Inventors: Alfred Memmel, Schonungen (DE); Christine Markert-Hess, Euerbach (DE); Thomas Nowotka, Ebelsbach (DE); Matthias Planitzer, Rothlein (DE); Horst Drescher, Werneck (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/270,033

(22) Filed: Nov. 9, 2005

(30) Foreign Application Priority Data
Nov. 10, 2004 (DE) 10 2004 054 205.8

(51) Int. Cl. F16F 9/04

(52) U.S. Cl. 267/64.27; 267/64.24

(57) ABSTRACT

Pneumatic spring comprises a rolling bellows, one end of which is attached to a connector part. The connector part has a profiling, which cooperates with a clamping ring to hold the rolling bellows in position. The profiling is in the form of a shoulder, against the axial surface of which the rolling bellows rests, where the rolling bellows is deformed axially by the clamping ring onto a radial clamping surface.

### BACKGROUND OF THE INVENTION

1. Field of the Invention

The invention relates to a pneumatic spring.

2. Description of the Related Art

An essential design feature of a pneumatic spring is the clamped connection between the rolling bellows and the cover or bottom piece. One possibility is to provide the rolling bellows with a reinforcing ring, which exerts radial tension against the cover or bottom piece. This design of the rolling bellows is very expensive, because the reinforcing ring must be encased during the production of the rolling bellows.

In many cases, a hose-like rolling bellows is attached to the bottom piece or to the cover by means of clamping rings. When a pneumatic spring is subjected to compression, the rolling bellows expands and, under certain conditions, can thus be pulled away from the cover or bottom piece. This is equivalent to a total failure of the pneumatic spring.

To avoid this situation, various types of clamping rings and clamping surface geometries on the bottom piece or cover are known.

For example, a clamping ring with a conical clamping surface is known from German Patent Application No. DE 41 18 576. Various forms of clamping rings and clamping surfaces are also described in German Patent Application No. DE 101 49 697, but these are comparatively expensive and require complicated mounting procedures to ensure that the clamping surfaces will be effective.

### SUMMARY OF THE INVENTION

An object of the present invention is to connect a rolling bellows to a connector part such as a cover or a bottom piece so that the connection is highly reliable in operation and is nevertheless easy to assemble.

The object is accomplished according to the invention in that a profiling is formed on the connector part by a shoulder, against the axial surface of which the rolling bellows rests, where the rolling bellows is deformed axially by the clamping ring onto a radial clamping surface.

The connector part requires only a very simple profile, which can be easily provided on components produced by injection-molding.

In another advantageous embodiment, the diameter of the clamping ring is smaller than the nominal diameter of the rolling bellows. No deformation forces acting on the clamping ring need to be exerted during assembly. As a result, a very simple material can be used for the clamping ring.

According to yet another embodiment, another axial clamping surface adjoins the radial clamping surface. This second axial clamping surface cooperates with the rolling bellows to form another seal, which is especially important when there is no pressure in the pneumatic spring.

The rolling bellows has a sealing fold, which proceeds from the radial clamping surface and encloses the clamping ring. Thus a pretensioning force, which is a function of the pressure inside the pneumatic spring, acts on the clamping ring. In addition, a lifting movement will be unable to pull the clamping ring away from the radial clamping surface.

On the end opposite the radial clamping surface, the axial surface has a stop surface for the end surface of the rolling bellows. This stop surface simplifies the assembly of the rolling bellows because the rolling bellows can be easily pushed over the connector part until it rests against the stop surface.

Another cost-reducing feature is that that the clamping ring can be formed by a round wire ring. The round wire ring is designed as a closed ring so that there are no ends which could press into the rolling bellows or lead to nonuniform pretension.

The second axial clamping surface, furthermore, can be provided with an annular groove. Especially when the sealing fold does not completely enclose the clamping ring, it is possible under certain pressure conditions for leaks to develop or for the rolling bellows to execute relative movement in the longitudinal direction of the pneumatic spring with respect to the axial and radial surfaces.

The annular groove is bounded by the radial clamping surface and by a circumferential web. The diameter of the circumferential web is larger than the outside diameter of the axial clamping surface so that the clamping ring can be easily installed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a schematic diagram of the pneumatic spring;

FIGS. 2a-2e show the sequence of steps involved in installing the rolling bellows on the roll-down tube;

FIGS. 3a-3d shows the cover of the pneumatic spring with the rolling bellows attached; and

FIG. 4 shows the sequence of steps involved in installing the rolling bellows on the cover according to FIG. 3.

### DETAILED DESCRIPTION OF THE PRESENTLY PREFERRED EMBODIMENTS

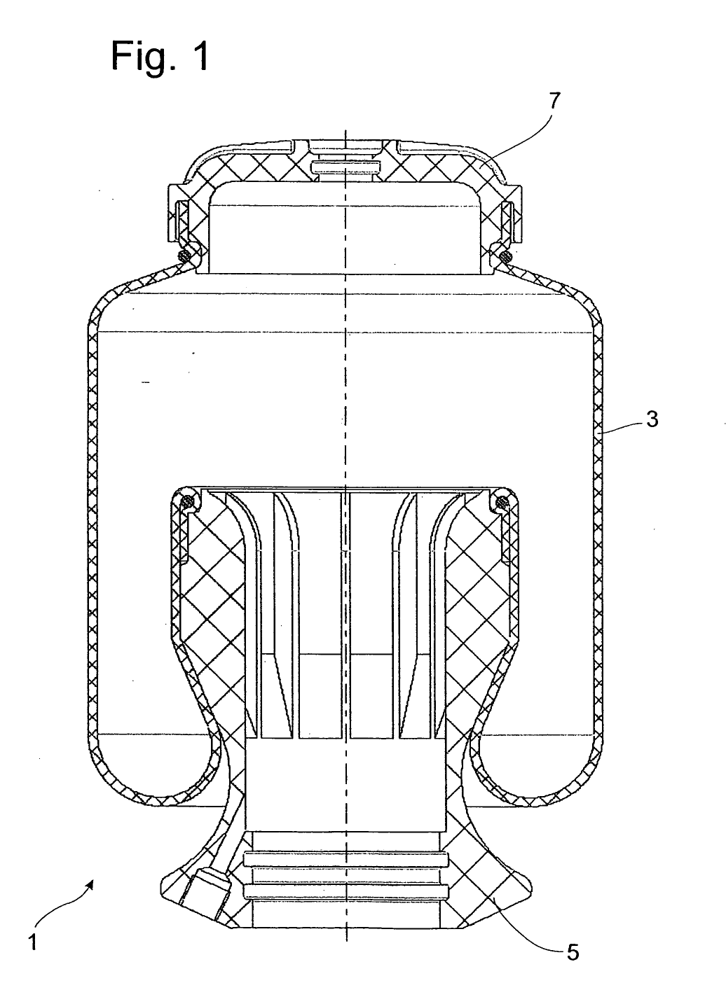

FIG. 1 shows a pneumatic spring 1, which has a rolling bellows 3. The bottom end of the rolling bellows 3 is connected to a roll-down tube 5, whereas its top end is connected to a cap 7, serving as a connector part. This structural assembly can be combined, for example, with a vibration damper, which carries the roll-down tube 5.

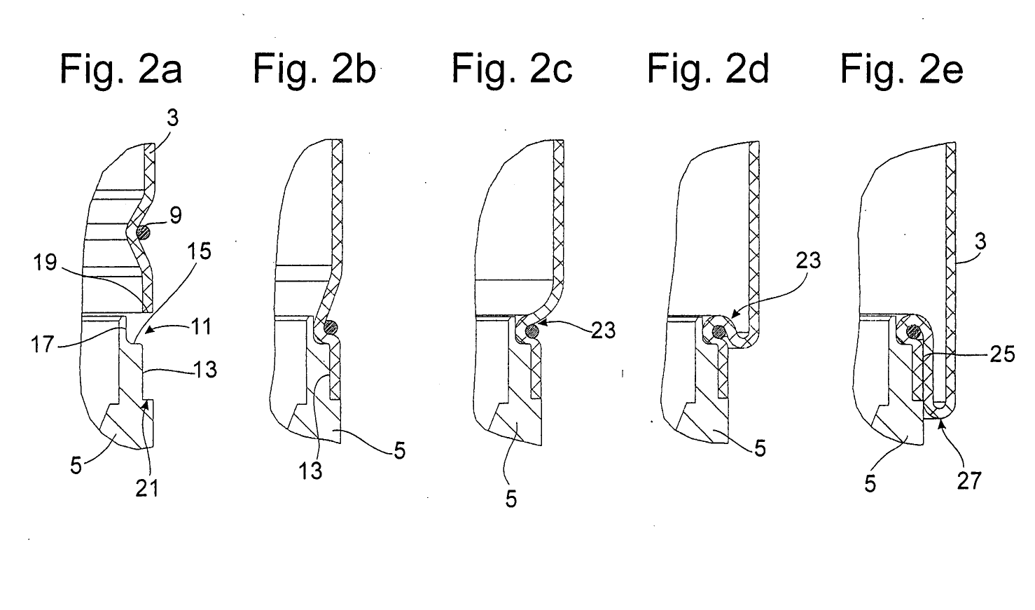

FIGS. 2a-2e illustrate the sequence of steps by which the rolling bellows 3 is mounted on the roll-down tube 5. The rolling bellows 3 is formed by a tubular body, which represents a semifinished product with a uniform cross section. This body is cut to the desired length from a strand. A clamping ring 9 is pushed onto the rolling bellows 3. The inside diameter of the clamping ring 9 is smaller than the outside diameter of the rolling bellows 3, as a result of which the rolling bellows 3 is squeezed inward to a slight degree. The clamping ring 9 is designed as an closed wire ring.

The roll-down tube has a profile with a shoulder 11, against the axial surface 13 of which (see also FIG. 1) the rolling bellows 3 is intended to rest. A radial clamping surface 15 adjoins the axial surface 13; the radial clamping surface 15 itself terminates at a second axial clamping surface 17.

In the next step, the rolling bellows 3 is pushed onto the roll-down tube. Its inside wall slides along the axial surface 13 until its end surface 19 comes up against a stop surface 21, which is at the opposite end of the axial surface 13 from the radial clamping surface 15. The clamping ring 9 pretensions the rolling bellows 3 against the transition contour extending from the axial surface 13 to the radial clamping surface 15.

A device (not shown), which is connected to the other end of the rolling bellows 3, is used to fill the rolling bellows 3 with pressure medium. As this is being done, a sealing fold 23 is formed, which pretensions the clamping ring 9 toward the radial clamping surface 15 and thus clamps the rolling bellows 3 axially in position. Then the rolling bellows 3 is pushed down axially as shown in FIG. 2d, as a result of which the sealing fold 23 completely encloses the clamping ring 9. In FIG. 2e, the pneumatic spring has assumed its intended working position. The exterior surface area 25 of the rolling bellows 3 between the sealing fold 23 and the reverse fold 27 rests against the end section of the rolling bellows 3. The pressure within the pneumatic spring thus acts via the exterior surface area 25 on the end of the rolling bellows 3 in the area of the axial surface 13, so that, overall, a pressure-dependent pretension acts on the shoulder 11.

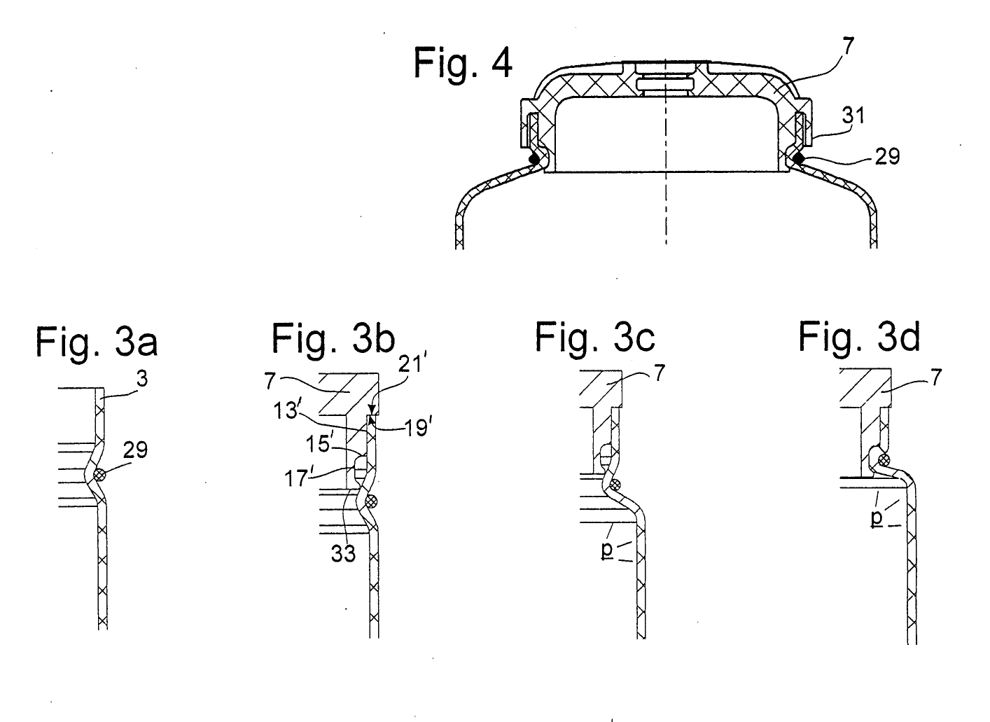

FIGS. 3a-3d illustrate the steps by which the rolling bellows 3 is attached to the cap 7 (see also FIG. 4). A clamping ring 29, functionally identical to the clamping ring 9, is fitted onto the top end of the rolling bellows 3, the inside diameter of this ring 29 again being smaller than the nominal diameter of the rolling bellows 3. The rolling bellows 3 is pushed onto the axial surface 13′ until the end surface 19′ rests against the stop surface 21′ of the cap 7. The end of the rolling bellows 3 can expand slightly, but a circumferential ring segment 31 (shown in FIG. 4) acts as a boundary. The ring segment 31 covers the upper end surface of the rolling bellows 3 and thus prevents dirt from intruding into this area. In FIGS. 3a-3d, the rolling bellows 3 is filled with pressure medium “p”, as a result of which the rolling bellows 3 expands radially and pushes the clamping ring 29 axially toward the cap 7. The cap 7 has a radial clamping surface 15′ designed in the same way as the radial clamping surface 15 on the roll-down tube 5, and it also has a second axial clamping surface 17′ (shown in FIG. 3b), which is designed with an annular groove, the boundaries of which are formed by the radial clamping surface 15′ and a circumferential web 33. The diameter of the circumferential web 33 is less than the outside diameter of the axial clamping surface 17′ and is intended to ensure a tight seal primarily at very low operating pressures inside the pneumatic spring. The circumferential web 33 also prevents the rolling bellows 3 from being pulled off the cap 7 at maximum load in the pressureless state. The overall sequence of assembly steps is therefore very simple, and there is no need for the clamping ring 29 to be radially pretensioned. On the contrary, an inelastic clamping ring can be used, which is installed and held in its predetermined position in the assembled state with the help of the operating pressure in the pneumatic spring.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pneumatic spring comprising:
a rolling bellows having an end portion;
a connector part having a first surface on which the end portion of the rolling bellows is mounted, and a second surface forming a shoulder, the second surface abutting the first surface; and
a clamping ring mounted on the rolling bellows so as to clamp the end portion of the rolling bellows on to the first surface and against the shoulder of the connector part.

2. The pneumatic spring of claim 1, wherein an inside diameter of the clamping ring is less than an outside diameter of the rolling bellows.

3. The pneumatic spring of claim 1, wherein the connector has a third surface onto which a portion of the rolling bellows is mounted.

4. The pneumatic spring of claim 1, wherein the rolling bellows has a sealing fold extending from the first surface and enclosing the clamping ring.

5. The pneumatic spring of claim 1, wherein the first surface has, at an end opposite the shoulder, a stop surface against which an end of the rolling bellows abuts.

6. The pneumatic spring of claim 1, wherein the clamping ring is a round wire ring.

7. The pneumatic spring of claim 6, wherein the round wire ring is a closed ring.

8. The pneumatic spring of claim 3, wherein the third surface has an annular groove.

9. The pneumatic spring of claim 8, further comprising a circumferential web wrapped about the connector part, wherein the annular groove is bounded by the first surface and the circumferential web.

10. The pneumatic spring of claim 9, wherein a diameter of the circumferential web is less than an outside diameter of the third surface.
